(19) United States
(12) Patent Application Publication
(10) Pub. No.: US 2010/0121728 A1
(43) Pub. Date: May 13, 2010

(54) LISTING WATCHER WITH ALERTS PUSHED TO MOBILE DEVICES

(76) Inventors: Ken Sun, Palo Alto, CA (US); Naoki Ogishi, San Mateo, CA (US)

Correspondence Address: SCHWEGMAN, LUNDBERG & WOESSNER/EBAY, P.O. BOX 2938, MINNEAPOLIS, MN, 55402, US

(21) Appl. No.: 12/268,380

(22) Filed: Nov. 10, 2008

(51) Int. Cl. G06Q 30/00

(52) U.S. Cl. 705/26

(57) ABSTRACT

A method and a system to communicate an alert to a mobile device are disclosed. The system receives, over a network, search information. The search information includes item description information that describes an item. The system repeatedly searches listings on a network-based marketplace to identify at least one listing that includes: an item that matches the item description information and is offered for sale in an auction on the network-based marketplace, a current highest bid for the item that is less than a price threshold, and a time remaining in the auction that is less than a predetermined time threshold. The system further communicates, over the network, the alert to the mobile device. The system communicates the alert responsive to the identification of the at least one listing.

### TECHNICAL FIELD

The present application relates generally to the technical field of data communications and, in one specific example, to data communications with a network-based marketplace.

### BACKGROUND

An auction of an item on a network-based marketplace or the publication of an item on a network-based marketplace may represent an opportunity to a buyer. Buyers continually evaluate listings of items for such opportunities and seek to acquire those items deemed desirable.

### BRIEF DESCRIPTION OF THE DRAWINGS

Some embodiments are illustrated by way of example and not limitation in the figures of the accompanying drawings in which:

FIG. 1 is a network diagram illustrating a networked system, according to an embodiment;

FIG. 2 is a block diagram illustrating marketplace applications and payment applications, according to an embodiment;

FIG. 3A is a block diagram illustrating navigation applications, according to an embodiment;

FIG. 3B is a block diagram illustrating listing creation applications, according to an embodiment;

FIG. 4A is a block diagram illustrating tables, according to an embodiment;

FIG. 4B is a block diagram illustrating a user table, according to an embodiment;

FIG. 5 is a block diagram illustrating an items table, according to an embodiment;

FIG. 6 is a block diagram illustrating item information, according to an embodiment;

FIG. 7A is a block diagram illustrating search information, according to an embodiment;

FIG. 7B is a block diagram illustrating search information, according to an embodiment;

FIG. 7C is a block diagram illustrating a search table, according to an embodiment;

FIG. 8 is a flow chart illustrating a method, according to an embodiment, to alert a mobile device;

FIG. 9 is a flow chart illustrating a method, according to an embodiment, to identify a listing;

FIG. 10 is a flow chart illustrating a method, according to an embodiment, to alert a mobile device;

FIG. 11 is diagram illustrating a user interface, according to an embodiment;

FIG. 12 is diagram illustrating a mobile device, according to an embodiment;

FIG. 13 shows a diagrammatic representation of a machine in the example form of a computer system, according to an example embodiment.

### DETAILED DESCRIPTION

Examples of a listing watcher are described. In the following description, for purposes of explanation, numerous specific details are set forth in order to provide a thorough understanding of example embodiments. It will be evident, however, to one skilled in the art that embodiments of the present disclosure may be practiced without these specific details.

Monitoring the progress of on-line transactions may be difficult from a mobile device. An auction of an item on a network-based marketplace or the publication of a listing of an item on a network-based marketplace may present technical challenges to an operator of the mobile device. Indeed, enabling the operator of the mobile device to adequately monitor highly dynamic changes in market conditions on a network-based marketplace that is remotely located may present technical challenges. Example technical challenges that may exist include overcoming the limited processing power of the mobile device and conserving network bandwidth.

In a first aspect of the present disclosure a bargain watcher is described. The bargain watcher helps a buyer watch listings of items that are being auctioned on a network-based marketplace. The buyer may enter search information to search for the item. The bargain watcher uses the search information to identify items that match the search information and that are offered in a soon to be completed auction for a bid that is below a price threshold. The bargain watcher continually searches for such items and responds to finding such items by communicating an alert over a network to a mobile device. One technical benefit of such an approach includes overcoming the limited processing power of the mobile device by using the processing power of the network-based marketplace to monitor the auction. Another technical benefit includes conserving network bandwidth by obviating any polling of the network-based marketplace. For example, polling may require multiple communications from the mobile device to the network-based marketplace with each communication using additional network bandwidth.

In a second aspect of the present disclosure a rare item watcher is described. The rare item watcher helps a buyer to watch item information for an item that is received by a network-based marketplace. The item information is used to publish listings of items on the network-based marketplace. The item information is communicated by sellers who want to create listings of items for publication on the network-based marketplace. The buyer may enter search information to search the item information as it is received by the network-based marketplace. The rare item watcher identifies listings of items that match the search information. The rare item watcher continually searches the received item information and responds to receipt of such item information by communicating an alert over a network to a mobile device. The same technical benefits as described above may be realized.

### Platform Architecture

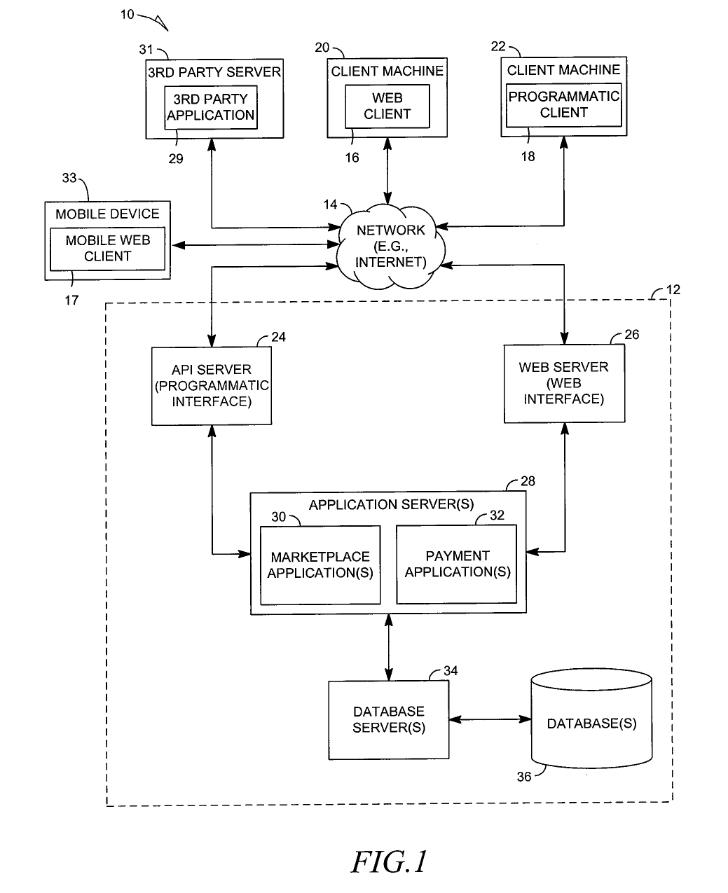

FIG. 1 is a network diagram depicting a networked system 10, within which one example embodiment may be deployed. A network-based marketplace 12 provides server-side functionality, via a network 14 (e.g., the Internet or Wide Area Network (WAN)) to one or more clients. FIG. 1 illustrates, for example, a web client 16 (e.g., a browser, such as the Internet Explorer browser developed by Microsoft Corporation of Redmond, Wash.) executing on client machines 20, a programmatic client 18 executing on a client machine 22, and a mobile web client 17 executing on mobile device 33. For example, the mobile web client 17 may be embodied as one or more mobile modules that are used to support the Blackberry™ wireless hand held business or smart phone manufactured by Research In Motion of Waterloo, Ontario.

An Application Program Interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more database servers 34 that facilitate access to one or more databases 36.

The marketplace applications 30 may provide a number of marketplace functions and services to users that access the network-based marketplace 12. The payment applications 32 may likewise provide a number of payment services and functions to users. The payment applications 32 may allow users to accumulate value in accounts, and then later to redeem the accumulated value for products (e.g., goods or services) that are made available via the marketplace applications 30. The value may be accumulated in a commercial currency, such as the U.S. dollar, or a proprietary currency, such as “points.” While the marketplace applications 30 and payment applications 32 are shown in FIG. 1 to both form part of the network-based marketplace 12, it will be appreciated that, in alternative embodiments, the payment applications 32 may form part of a payment service that is separate and distinct from the network-based marketplace 12.

Further, while the networked system 10 shown in FIG. 1 employs a client-server architecture, embodiments of the present invention are of course not limited to such an architecture, and could equally well find application in a distributed, or peer-to-peer, architecture system, for example. The various marketplace applications 30 and payment applications 32 could also be implemented as standalone software programs, which do not necessarily have networking capabilities.

The web client 16 and mobile web client 17 accesses the various marketplace applications 30 and payment applications 32 via the web interface supported by the web server 26. Similarly, the programmatic client 18 accesses the various services and functions provided by the marketplace applications 30 and payment applications 32 via the programmatic interface provided by the API server 24. The programmatic client 18 may, for example, be a seller application (e.g., the TurboLister application developed by eBay Inc., of San Jose, Calif.) to enable sellers to author and manage listings on the network-based marketplace 12 in an off-line manner, and to perform batch-mode communications between the programmatic client 18 and the network-based marketplace 12.

FIG. 1 also illustrates a third party application 29, executing on a third party server machine 31, as having programmatic access to the networked system 10 via the programmatic interface provided by the API server 24. For example, the third party application 29 may, utilizing information retrieved from the network-based marketplace 12, support one or more features or functions on a website hosted by the third party. The third party website may, for example, provide one or more promotional, marketplace or payment functions that are supported by the relevant applications of the networked system 10.

The mobile device 33 may be used to communicate information to the network-based marketplace 12 and receive information from the network-based marketplace 12. In one embodiment the network-based marketplace 12 may receive search information from the mobile device 33. For example, the network-based marketplace may use the search information to search for the items that are offered for sale on the network-based marketplace 12. The network-based marketplace may communicate alerts back to the mobile device 33 in response to finding the sought after items. The mobile device 33 may be embodied as a mobile phone, a personal digital assistant, a cell phone, or any other wireless device that is capable of communicating with the network-based marketplace 12. For example, the mobile device 33 may be embodied as an iPhone manufactured by Apple, Inc. of Cupertino, Calif. or, as previously mentioned, or a Blackberry™ manufactured by Research In Motion of Waterloo, Ontario.

### Marketplace and Payment Applications

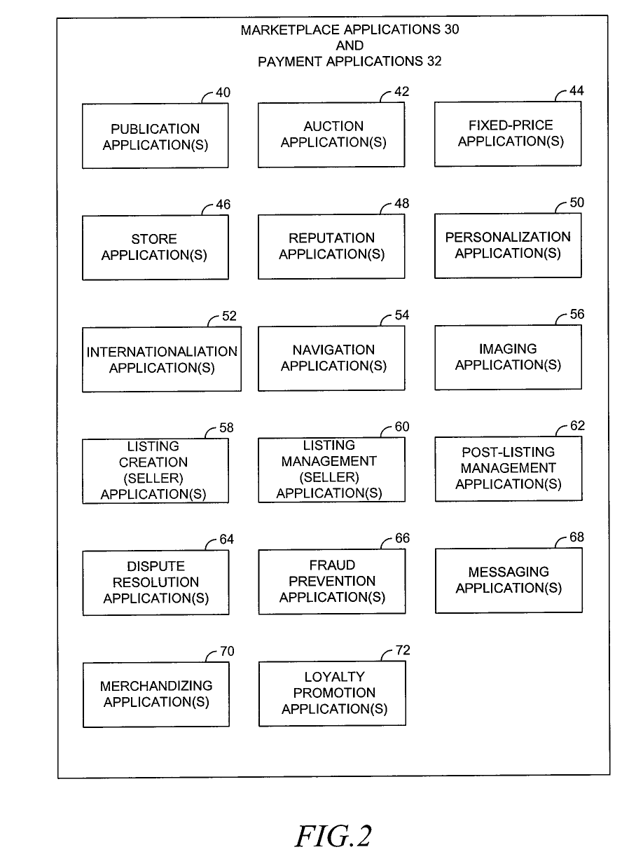

FIG. 2 is a block diagram illustrating marketplace applications 30 and payment applications 32 that, in one example embodiment, are provided as part of the networked system 10. The marketplace applications 30 and payment applications 32 may be hosted on dedicated or shared server machines, as shown on FIG. 1, that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 36 via the database servers 34.

The network-based marketplace 12 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 30 are shown to include at least one publication application 40 and one or more auction applications 42 which support auction-format listing and price setting mechanisms (e.g., English, Dutch, Vickrey, Chinese, Double, Reverse auctions etc.). The various auction applications 42 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 44 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store application(s) 46 allows a seller to group listings within a “virtual” store, which may be branded and otherwise personalized by and for the seller. Such a virtual store may also offer promotions, incentives and features that are specific and personalized to a relevant seller.

Reputation applications 48 allow users that transact, utilizing the network-based marketplace 12, to establish, build and maintain reputations, which may be made available and published to potential trading partners. Consider that where, for example, the network-based marketplace 12 supports person-to-person trading, users may otherwise have no history or other reference information whereby the trustworthiness and credibility of potential trading partners may be assessed. The reputation applications 48 allow a user, for example through feedback provided by other transaction partners, to establish a reputation within the network-based marketplace 12 over time. Other potential trading partners may then reference such a reputation for the purposes of assessing credibility and trustworthiness.

Personalization applications 50 allow users of the network-based marketplace 12 to personalize various aspects of their interactions with the network-based marketplace 12. For example a user may, utilizing an appropriate personalization application 50, create a personalized reference page at which information regarding transactions to which the user is (or has been) a party may be viewed. Further, a personalization application 50 may enable a user to personalize listings and other aspects of their interactions with the networked system 10 and other parties.

The networked system 10 may support a number of marketplaces that are customized, for example, for specific geographic regions. A version of the networked system 10 may be customized for the United Kingdom, whereas another version of the networked system 10 may be customized for the United States. Some of these versions may operate as an independent marketplace, or may be customized (or internationalized) presentations of a common underlying marketplace. The networked system 10 may accordingly include a number of internationalization applications 52 that customize information (and/or the presentation of information) by the networked system 10 according to predetermined criteria (e.g., geographic, demographic or marketplace criteria). For example, the internationalization applications 52 may be used to support the customization of information for a number of regional websites that are operated by the networked system 10 and that are accessible via respective servers 24 and 26.

Navigation of the networked-based marketplace 12 may be facilitated by one or more navigation applications 54. For example, a search module (as an example of a navigation application) may enable key word searches of listings before and after publication of the listings via the networked system 10. A browse application may allow users to browse various category, catalogue, or inventory data structures according to which listings may be classified within the networked system 10. Various other navigation applications may be provided to supplement the search and browsing applications.

In order to make listings, available via the networked system 10, as visually informing and attractive as possible, the marketplace applications 30 may include one or more imaging applications 56 with which users may upload images for inclusion within listings. An imaging application 56 also operates to incorporate images within viewed listings. The imaging applications 56 may also support one or more promotional features, such as image galleries that are presented to potential buyers. For example, sellers may pay an additional fee to have an image included within a gallery of images for promoted items.

Listing creation applications 58 allow sellers conveniently to author listings pertaining to goods or services that they wish to transact via the network-based marketplace 12. The listing management applications 60 allow sellers to manage such listings. Specifically, where a particular seller has authored and/or published a large number of listings, the management of such listings may present a challenge. The listing creation applications may further include a processing module, communication module, and listing module that facilitate a buyer watching for specific types of listings. The listing management applications 60 provide a number of features (e.g., auto-relisting, inventory level monitors, etc.) to assist the seller in managing such listings. One or more post-listing management applications 62 also assist sellers with a number of activities that may typically occur post-listing. For example, upon completion of an auction facilitated by one or more auction applications 42, a seller may wish to leave feedback regarding a particular buyer. To this end, a post-listing management application 62 may provide an interface to one or more reputation applications 48, so as to allow the seller conveniently to provide feedback regarding multiple buyers to the reputation applications 48.

Dispute resolution applications 64 provide mechanisms whereby disputes arising between transacting parties may be resolved. For example, the dispute resolution applications 64 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 66 implement fraud detection and prevention mechanisms to reduce the occurrence of fraud within the network-based marketplace 12.

Messaging applications 68 are responsible for the generation and delivery of messages to users of the network-based marketplace 12, such messages for example advising users regarding the status of listings at the network-based marketplace 12 (e.g., providing “outbid” notices to bidders during an auction process or to provide promotional and merchandising information to users). Respective messaging applications 68 may utilize any one of a number of message delivery networks and platforms to deliver messages to users. For example, messaging applications 68 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 70 support various merchandising functions that are made available to sellers to enable sellers to increase sales via the network-based marketplace 12. The merchandising applications 70 also operate the various merchandising features that may be invoked by sellers, and may monitor and track the success of merchandising strategies employed by sellers.

The network-based marketplace 12 itself, or one or more parties that transact via the network-based marketplace 12, may operate loyalty programs that are supported by one or more loyalty/promotions applications 72. For example, a buyer may earn loyalty or promotions points for transactions established and/or concluded with a particular seller, and then be offered a reward for which accumulated loyalty points can be redeemed.

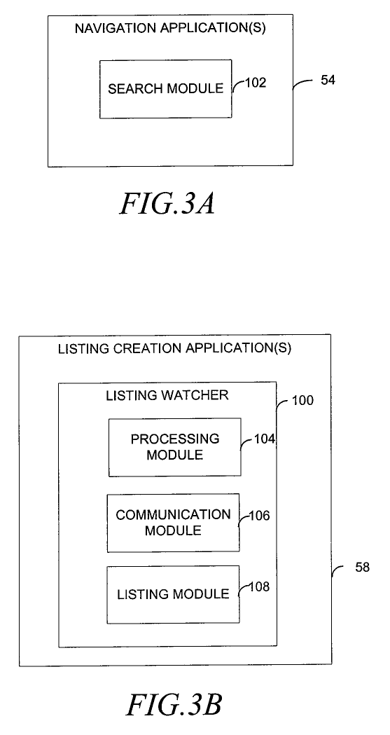

FIG. 3A is a block diagram illustrating navigation applications 54, according to an embodiment. The navigation applications 54 include a search module 102. The search module 102 may receive search information from a user. The search information may describe an item that the user is looking for on the network-based marketplace.

FIG. 3B is a block diagram illustrating listing creation applications 58, according to an embodiment. The listing creation application 58 includes a listing watcher 100 to watch listings. The listing watcher 100 includes a processing module 104, a communication module 106, and a listing module 108. The processing module 104 may be used to search for bargain items on the network-based marketplace 12. For example, the processing module 104 may use the search information to periodically search the items on the network-based marketplace 12 based on the search information to identify the bargain items. The communication module 106 may be used to communicate an alert over a network to a mobile device 33. The listing module 108 may be used to search for rare items on the network-based marketplace 12. For example, the listing module 108 may be used to search item information that is received from users seeking to publish a listing of an item for purchase or auction on the network-based marketplace.

### Data Structures

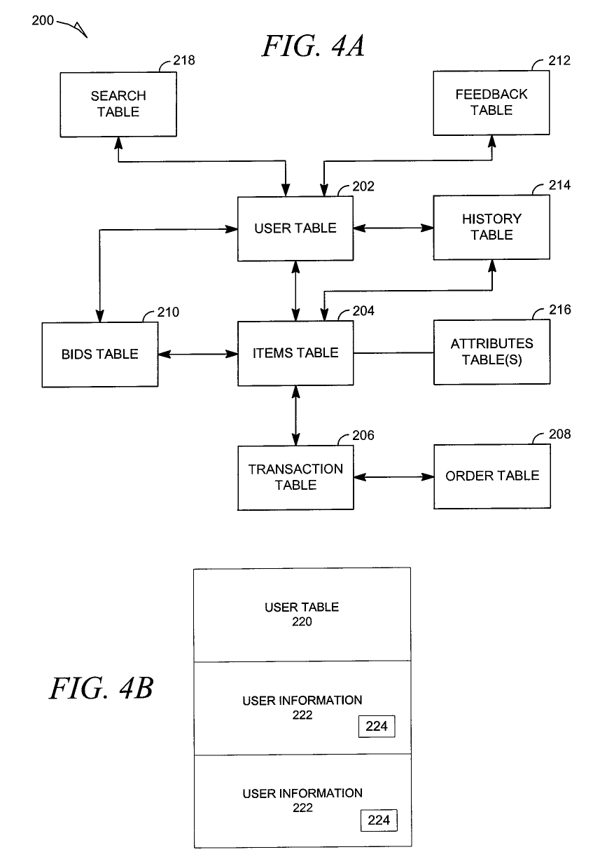

FIG. 4A is a high-level entity-relationship diagram, illustrating various tables 200 that may be maintained within the databases 36, and that are utilized by and support the marketplace applications 30 and payment applications 32. A user table 202 contains a record for registered users of the network-based marketplace 12. A user may operate as a seller, a buyer, or both, within the network-based marketplace 12. In one example embodiment, a buyer may be a user that has accumulated value (e.g., commercial or proprietary currency), and is accordingly able to exchange the accumulated value for items that are offered for sale by the network-based marketplace 12.

The tables 200 also include an items table 204 in which are maintained item records for goods and services that are available to be, or have been, transacted via the network-based marketplace 12. Item records within the items table 204 may furthermore be linked to one or more user records within the user table 202, so as to associate a seller and one or more actual or potential buyers with an item record.

A transaction table 206 contains a record for each transaction (e.g., a purchase or sale transaction) pertaining to items for which records exist within the items table 204.

An order table 208 is populated with order records, each order record being associated with an order. Each order, in turn, may be associated with one or more transactions for which records exist within the transaction table 206.

Bid records within a bids table 210 relate to a bid received at the network-based marketplace 12 in connection with an auction-format listing supported by an auction application 42. A feedback table 212 is utilized by one or more reputation applications 48, in one example embodiment, to construct and maintain reputation information concerning users. A history table 214 maintains a history of transactions to which a user has been a party. One or more attributes tables 216 record attribute information pertaining to items for which records exist within the items table 204. Considering only a single example of such an attribute, the attributes tables 216 may indicate a currency attribute associated with a particular item, the currency attribute identifying the currency of a price for the relevant item as specified in by a seller.

A search table 218 may store search information that has been entered by a user (e.g., buyer) who is looking for a specific type of listings. The network-based marketplace 12 may use the search table 218 to continually search for items offered at a bargain or to identify rare items as they are listed on the network-based marketplace 12.

FIG. 4B is a block diagram illustrating a user table 220, according to an embodiment. The user table stores user information 222 for each registered user of the network-based marketplace 12. The user information 222 includes a feedback score 224. The feedback score 224 may be embodied as a numeric value that is generated based on feedback provided by transaction partners associated with the user. For example, a high feedback score may indicate transaction partners that have reported favorable feedback based on previous transactions with the user and a low feedback score may indicate transaction partners that have reported unfavorable feedback based on previous transactions with the user. The feedback score 224, over time, may be used by the user to establish a reputation within the network-based marketplace 12. Potential trading partners may reference the feedback score 224 to assess the credibility and trustworthiness of the user.

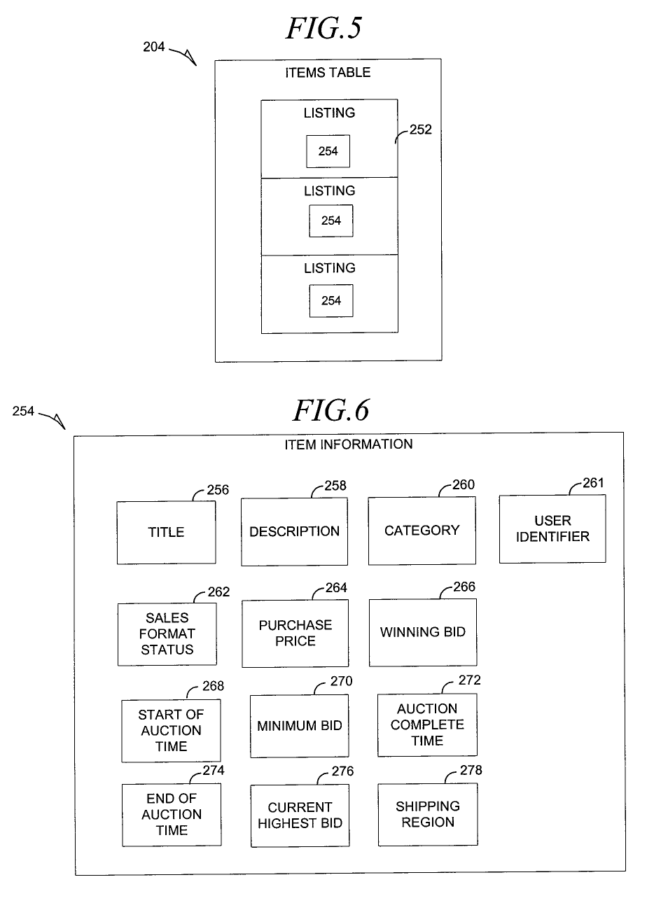

FIG. 5 is a block diagram illustrating an items table 204, according to an embodiment. The items table 204 includes listings 252 that respectively describe items to be transacted, items that are being transacted, or items that have already been transacted on the network-based marketplace 12. For example, a listing 252 may describe an item to be auctioned for sale at a future date, an item presently being auctioned for sale, or an item that was previously auctioned for sale. An auction may complete with or without a winning bidder. A listing may include item information 254, as described below.

FIG. 6 is a block diagram illustrating item information 254, according to an embodiment. The item information 254 includes a title 256, a description 258, a category 260, a user identifier 261, a sales format status 262, a purchase price 264, a winning bid 266, a start of auction time 268, a minimum bid 270, an auction complete time 272, an end of auction time 274, a current highest bid 276, and a shipping region 278. The title 256 may store text (e.g., alphanumeric information) that is used as a title of the listing. The description 258 also stores text that is descriptive of the item(s) offered by the listing 252 and typically includes more text than the title 256. The category 260 may store one or more categories that may be used to categorize the listing 252 to enable a user to browse categories to view the listings 252. The user identifier 261 identifies the user (e.g., seller) that entered the listing 252 on the network-based marketplace 12. The sales format status 262 stores a status that identifies the item as offered at a fixed price, offered in an auction, or both. The purchase price 264 is an amount of value paid for an item that was purchased at a fixed price. The winning bid 266 is an amount of value paid for an item won in an auction. The start of auction time 268 and end of auction time 274 are the start and end times of an auction. The start of auction time 268 may be used by the network-based marketplace 12 to start the auction and end of auction time 274 may be used by the network-based marketplace 12 to end the auction. The minimum bid 270 may be a least amount for a bid to be a winning bid in an auction sometimes referred to as a reserve price. For example, an auction may complete without a winning bidder if all of the submitted bids are below the minimum bid 270. The current highest bid 276 is the current highest bid in an auction. The shipping region 278 stores the region(s) where a seller is willing to ship the item. Accordingly, the shipping region 278 limits where the seller is willing to sell. The shipping region 278 may include a country (e.g., England), a region (e.g., North America), a state (e.g., California) or any other geographic designation.

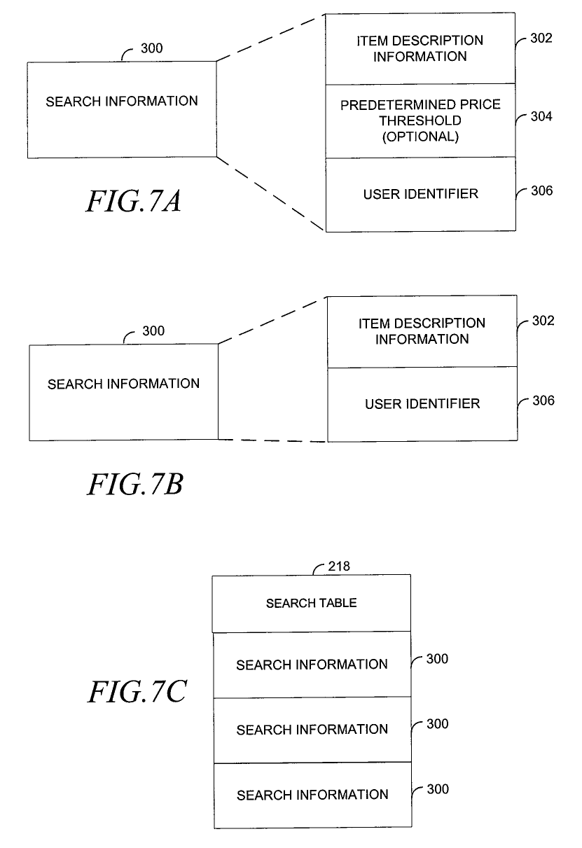

FIG. 7A is a block diagram illustrating search information 300, according to an embodiment. In a first aspect of the present disclosure, the search information 300 may be received by the network-based marketplace 12 to request the network-based marketplace 12 to search for an item that is presently offered for sale in an auction. The search information 300 may include item description information 302, a predetermined price threshold 304 that is optional, and a user identifier 306. The item description information 302 may describe the sought after item. For example, the item description information 302 may include a keyword(s), a category(s), a price, a price range, keywords not included in the listing 252, a shipping region or any other information that is used to search the item information 254 in the items table 204. For example, the keyword(s) may be used to search the title 256, as also shown on FIG. 6, and/or the description 258, as also shown on FIG. 6. The predetermined price threshold 304 is optional. The predetermined price threshold 304 may be used to identify a bargain. For example, the network-based marketplace 12 may identify a listing of an item with a current highest bid 276, as shown on FIG. 6, which is less than the predetermined price threshold 304. The user identifier 306 may identify the user that originated the requested search. For example, the user identifier 306 may be used to identify the user in the user table 202 as shown on FIG. 4A. The user identifier 306 corresponds to the user identifier 261 on FIG. 6. The user may communicate the search information 300 from the mobile device 33, the client machine 20, or the client machine 22 as shown on FIG. 1.

FIG. 7B is a block diagram illustrating search information 300, according to an embodiment. In a second aspect of the present disclosure, the search information 300 may be received by the network-based marketplace 12 to request the network-based marketplace 12 to search for a rare item responsive to receiving item information for an item from a seller for publication of a listing of the item on the network-based marketplace 12. The search information 300 may include item description information 302, as previously described, and a user identifier 306, as previously described.

FIG. 7C is a block diagram illustrating a search table 218, according to an embodiment. The search table 218 may be used to store search information 300 that is received by the network-based marketplace 12.

### Flow Charts

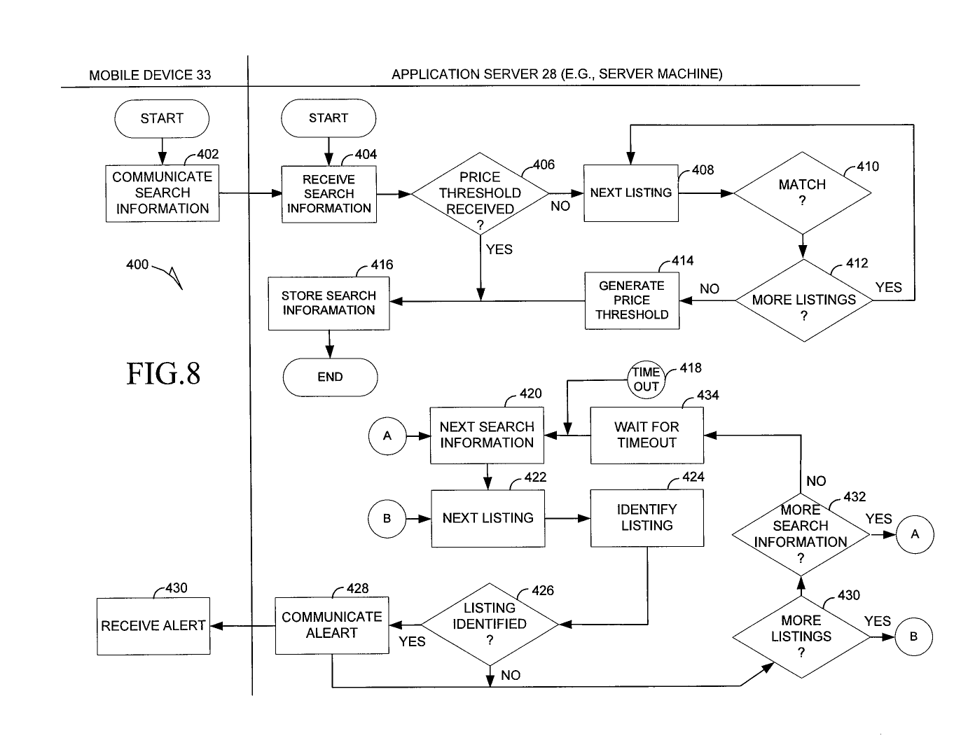

FIG. 8 is a flow chart illustrating a method 400, according to an embodiment, to communicate an alert to a mobile device 33. Illustrated on the left are operations performed at the mobile device 33 and illustrated on the right are operations performed by the application server 28 (e.g., server machine). The method 400 commences at operation 402 with a user operating the mobile device 33 to request a search for an item that is being auctioned at a bargain on the network-based marketplace 12. For example, the user may enter search information 300 that is received by the mobile web client 17 that, in turn, communicates the search information 30 to the network-based marketplace 12. It will be appreciated by one having ordinary skill in the art that the search information 300 may also be communicated by a user who is operating a client machine 20, that is hosting a web client 16 or a client machine 22, which is hosting a programmatic client 18.

At operation 404, at the application server 28, the search module 102 receives the search information 300 and at decision operation 406 the processing module 104 identifies whether the search information 300 includes a predetermined price threshold 304. If the processing module 104 determines the search information 300 includes a predetermined price threshold 304 then a branch is made to operation 416. Otherwise a branch is made to decision operation 408.

At operations 408-414, the processing module 104 generates the price threshold based on listings 252 stored in the items table 204. At operation 408, the processing module 104 retrieves the next listing 252 from the items table 204. At decision operation 410, the processing module 104 identifies whether the search information 300 received from the user matches the listing 252. For example, the processing module 104 may compare the item description information 302 in the search information 300 with the item information 243 in the listing 242 to identify the match. The processing module 104 may further require the listing 252 to include a winning bid 266. Accordingly, the listings 252 matched or found by the processing module 104 include items that both match the search information 300 and were previously auctioned for an amount specified by the winning bid 266.

At decision operation 412, the processing module 104 identifies whether more listings 252 are in the items table 204. If more listings 252 are in the items table 204 then a branch is made to operation 408. Otherwise a branch is made to operation 414. At operation 414, the processing module 104 generates the price threshold based on the matched listings. For example, the processing module 104 may generate the price threshold based on an average of the winning bids 266. In another embodiment, the processing module 104 may generate the price threshold based on a median of the winning bids 266. At operation 416, the processing module 104 stores the search information 300 in the search table 218 and the process ends.

At operation 418, a time out causes the processing module 104, at operation 420, to retrieve search information 300 from the search table 218. At operation 422, the processing module 104 retrieves a listing 252 from the items table 204. At operation 424, the processing module 104 identifies whether the listing 252 matches the search information 300, as described further on FIG. 8.

At operation 426, the processing module 104 identifies whether a listing 252 was identified. If a listing 252 was identified a branch is made to operation 428. Otherwise a branch is made to decision operation 430. At decision operation 430, the processing module 104 identifies whether more listings 252 are in the items table 204. If more listings 252 are in the items table 204 then a branch is made to operation 422. Otherwise a branch is made to decision operation 432. At decision operation 432, the processing module 104 identifies whether more search information 300 is in the search table 218. If more search information 300 is in the search table 218 then a branch is made to operation 420. Otherwise a branch is made to operation 434. At operation 434, the processing module 104 sets a timeout and processing ends. In one embodiment, the timeout may be a length of time that is configured by the buyer.

At operation 428, the communication module 106 communicates an alert to the mobile device 33. For example, the alert may inform the user of the mobile device 33 that a bargain has been found. The alert may be embodied as an email, a short message service (SMS) message, an instant message, or a Blackberry Inbox Item.

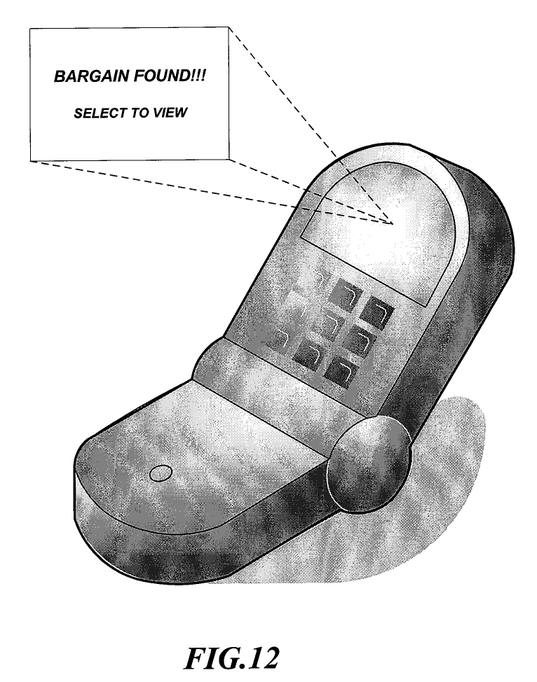

At operation 430, the mobile device 33 receives and displays an interface that includes the alert. For example, FIG. 12 is a diagram that illustrates a mobile device 33 that includes a user interface that displays an alert in the form of an SMS message that informs the user of a bargain that was found on the network-based marketplace 12.

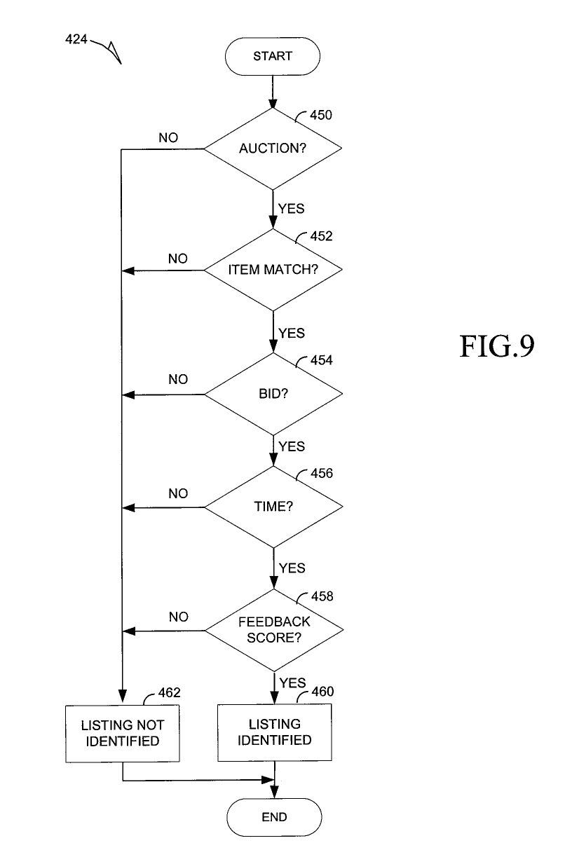

FIG. 9 is a flow chart illustrating a method 424, according to an embodiment, to identify a listing 252. The method 424 corresponds to the operation 424 on FIG. 8. The method commences at decision operation 450 with the processing module 104 identifying whether the listing 252 is for an item that is presently being auctioned. For example, the processing module 104 may identify that the listing 252 is for an item that is presently being auctioned based on the start of auction time 268 and the end of auction time 275 in the listing 252. Specifically, if the current time is between the start of auction time 268 and the end of auction time 275 and the auction is not complete (e.g., item purchased at a fixed price to bring an early termination to the auction) then the auction is live. If the auction is live a branch is made to decision operation 452. Otherwise a branch is made to operation 462.

At decision operation 452, the processing module 104 identifies whether the search information 300 matches the item in the listing 252. For example, the processing module 104 may compare the item description information 302 in the search information 300 with the item information 254 in the listing 252. If the search information 300 matches the listing 252 then a branch is made to decision operation 454. Otherwise a branch is made to operation 462.

At decision operation 454, the processing module 104 identifies whether the listing 252 includes a current highest bid 276 that is less than the price threshold. For example, the processing module 104 may compare the predetermined price threshold 304 in the search information 300 with the current highest bid 276 in the listing 252. In another example, the processing module 104 may compare a price threshold 304 that was generated by the network-based marketplace 12 based on listings 252 from the items table 204, as previously described. If the current highest bid 276 is less than the price threshold then a branch is made to decision operation 456. Otherwise a branch is made to operation 462.

At decision operation 456, the processing module 104 identifies whether the time remaining in the auction is less than a predetermined time threshold. For example, the processing module 104 may compare a predetermined time threshold of five minutes with the difference between the end of auction time 274 and the current time. In one embodiment, the predetermined threshold may be configurable for the network-based marketplace 12. For example, a network administrator may configure the predetermined time threshold for the network-based marketplace 12. In one embodiment, the predetermined time threshold may be configurable by the user. For example, the networked system may receive the predetermined time threshold as search information 300. If the time remaining in the auction is less than the predetermined time threshold then a branch is made to decision operation 458. Otherwise a branch is made to operation 462.

At decision operation 458, the processing module 104 identifies whether the feedback score 224 associated with the user (e.g., seller) that entered the listing 252 is greater than a predetermined feedback threshold. For example, the processing module 104 may identify the feedback score 224 in the user table 220 based on the user identifier 261 in the listing 252 and compare the feedback score 224 with the predetermined feedback threshold. If the feedback score 224 associated with the user that entered the listing 252 is greater than a predetermined feedback threshold then a branch is made to operation 460. Otherwise a branch is made to operation 462.

At operation 460, the processing module 104 identifies the listing 252 as matched and processing resumes at decision operation 426 on FIG. 8. Otherwise, at operation 462, the processing module 104 does not identify the listing 252 as matched and processing resumes at decision operation 426 on FIG. 8.

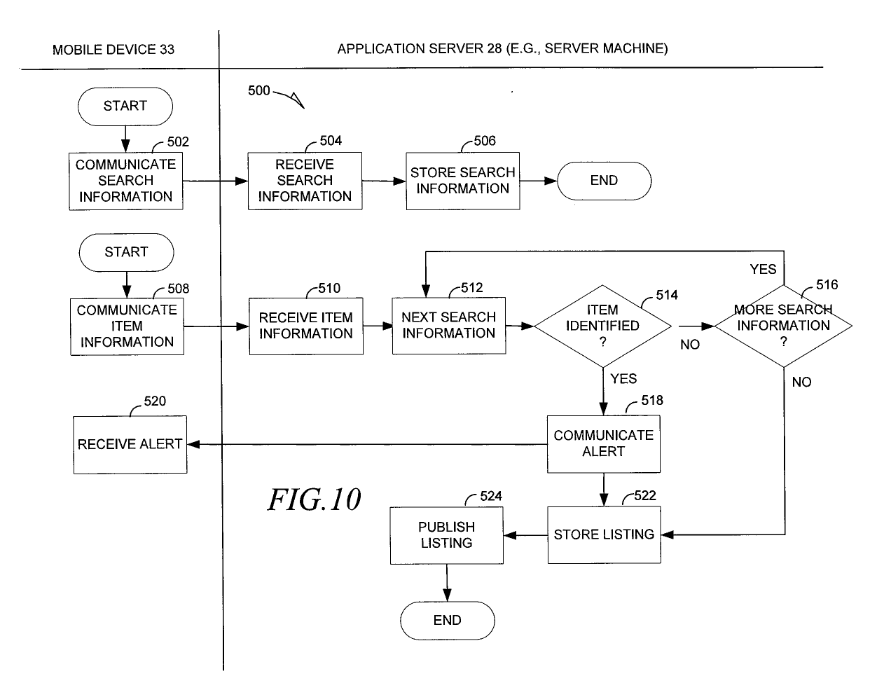

FIG. 10 is a flow chart illustrating a method 500, according to an embodiment, to communicate an alert to a mobile device. Illustrated on the left are operations performed at the mobile device 33 and illustrated on the right are operations performed by the application server 28. The method 500 commences at operation 502 with a user operating the mobile device 33 to request a search for a rare item on the network-based marketplace 12. For example, the user may enter search information 300 that is received by the mobile web client 17 that, in turn, communicates the search information 300 to the network-based marketplace 12. It will be appreciated by one having ordinary skill in the art that the search information 300 may also be communicated by a user who is operating a client machine 20 that is hosting a web client 16 or by a client machine 22 that is hosting a programmatic client 18.

At operation 504, at the application server 28, the search module 102 receives the search information 300 and at operation 506 the processing module 104 stores the search information 300 in the search table 218 and the process ends.

At operation 508, a user (e.g., seller) enters item information 254 for an item to enable the network-based marketplace 12 to publish a listing of the item on the network-based marketplace 12. For example, the user may operate the mobile device 33 to communicate the item information 254 to the network-based marketplace 12. Also, for example, the user may operate the client machine 20 to communicate item information 254 to the network-based marketplace 12

At operation 510, at the application server 28, the listing module 108 receives the item information 254. For example, the listing module 108 may receive the item information 254 that describes an item to be offered at a fixed price or offered in an auction or both. At operation 512, the processing module 104 retrieves the search information 300 from the search table 218. At decision operation 514, the processing module 104 may identify whether the item matches the search information 300. For example, the processing module 104 identifies whether the search information 300 matches the item information 254 in the listing 252. If the processing module 104 identifies a match then a branch is made to operation 518. Otherwise a branch is made to operation 516.

At decision operation 516, the processing module 104 identifies whether more search information 300 is in the search table 218. If more search information 300 is in the search table 218 a branch is made to operation 512. Otherwise a branch is made to operation 522. At operation 522, the listing module stores the listing 252 in the items table 204. At operation 524, the listing module publishes the listing 252 on the network-based marketplace 12. For example, publishing the listing 252 causes the listing to appear on user interfaces that enable users (e.g., buyers) to view the listing on the network-based marketplace 12 and to enter bids for the item and/or agree to pay a purchase price for the item.

At operation 518, the communication module 106 communicates the alert to the mobile device 33. For example, the alert may indicate that the network-based marketplace 12 has received a listing for a rare item. The alert may be embodied as an email, a short message service (SMS) message, an instant message, or a Blackberry Inbox Item. In one embodiment, the alert may be communicated before the listing 252 is published on the network-based marketplace 12.

At operation 520, the mobile device 33 receives and displays the alert, as previously described.

### User Interfaces

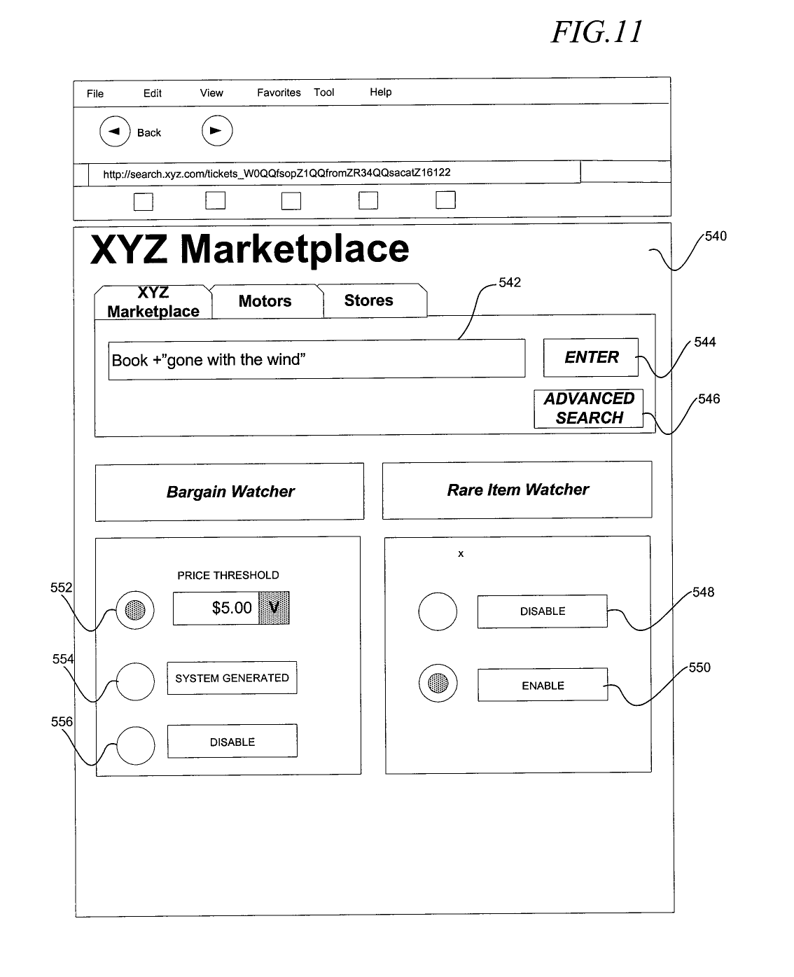

FIG. 11 is a diagram illustrating a user interface 540, according to an embodiment. The user interface 540 may be used by a user to communicate search information 300 to the network-based marketplace 12. The user interface 540 includes an input box 542 to receive keywords that may be used to search the title 256, as shown on FIG. 6, and/or the description 258, as also shown on FIG. 6. The user interface 540 further includes an enter button 544 to submit the keywords in the input box 542 and an advance search button 546 to submit other item information 254 (e.g., category, purchase price, price range, a plurality of keywords not include in the listing 252, shipping region, etc.) to the network-based marketplace 12. The user interface 540 further includes a user interface control 548 for a “Bargain Watcher” and user interface control 550 for a “Rare Item Watcher.”

The user interface control for the “Bargain Watcher” includes the user interface controls 552, 554 and 556. The user interface control 552 enables the user to enter a predetermined price threshold 304 that may be received by the network-based marketplace 12. For example, the network-based marketplace 12 may identify listings 252 for items that are presently being auctioned at a current highest bid 276 that is below the predetermined price threshold 304. The user interface control 554 enables the user to request the network-based marketplace 12 to generate a price threshold. For example, the network-based marketplace 12 may generate a price threshold based on listings 252 of items that have been auctioned, as previously described. The user interface control 554 enables the user to request the network-based marketplace 12 to disable the “Bargain Watcher” feature.

The user interface controls 548 for the “Rare Item Watcher” include user interface controls 558 and 560. The user interface control 558 enables the user to request the network-based marketplace 12 to enable the “Rare Item Watcher” feature and the user interface control 560 enables the user to request the network-based marketplace 12 to disable the “Rare Item Watcher” feature.

In some embodiments, the methods 400 and 500 may be implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level, and communicates the results of these logical/mathematical manipulations to the interface tier, and/or to a backend, or storage tier. These logical/mathematical manipulations may relate to certain business rules, or processes that govern the software application as a whole. A third, storage tier, may be a persistent storage medium or, non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. This three-tier architecture may be implemented using one technology, or, as will be discussed below, a variety of technologies. This three-tier architecture, and the technologies through which it is implemented, may be executed on two or more computer systems organized in a server-client, peer to peer, or so some other suitable configuration. Further, these three tiers may be distributed between multiple computer systems as various software components.

Some example embodiments may include the above illustrated tiers, and processes or operations that make them up, as being written as one or more software components. Common to many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique. These components may be linked to other components via various Application Programming interfaces (APIs), and then compiled into one complete server, client, and/or peer software application. Further, these APIs may be able to communicate through various distributed programming protocols as distributed computing components.

Some example embodiments may include remote procedure calls being used to implement one or more of the above illustrated components across a distributed programming environment as distributed computing components. For example, an interface component (e.g., an interface tier) may reside on a first computer system that is remotely located from a second computer system containing a logic component (e.g., a logic tier). These first and second computer systems may be configured in a server-client, peer-to-peer, or some other suitable configuration. These various components may be written using the above illustrated object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language by using a distributed computing protocol such as a Common Object Request Broker Architecture (CORBA), a Simple Object Access Protocol (SOAP), or some other suitable protocol. Some embodiments may include the use of one or more of these protocols with the various protocols outlined in the OSI model, or TCP/IP protocol stack model for defining the protocols used by a network to transmit data.

Some embodiments may utilize the OSI model or TCP/IP protocol stack model for defining the protocols used by a network to transmit data. In applying these models, a system of data transmission between a server and client, or between peer computer systems is illustrated as a series of roughly five layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

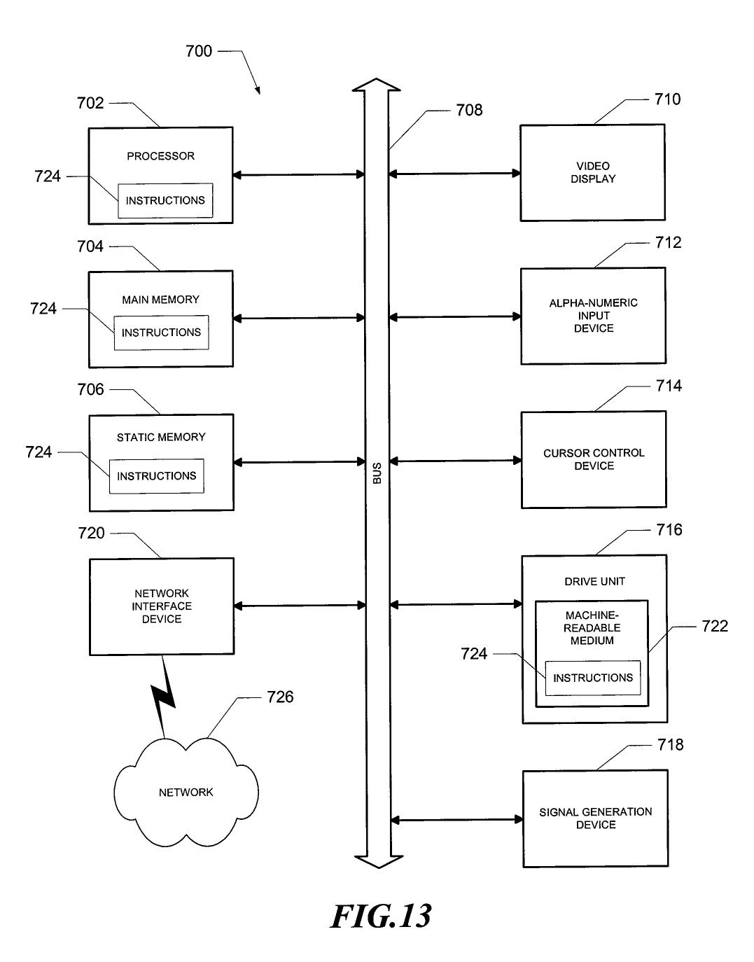

FIG. 13 shows a diagrammatic representation of a machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server machine or a client machine in client-server network environment, or as a peer machine in a peer-to-peer (or distributed) network environment. The machine may be a server computer, a client computer, a personal computer (PC), a tablet PC, a set-top box (STB), a Personal Digital Assistant (PDA), a mobile device, a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g. a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations. In example embodiments, a computer system (e.g., a standalone, client or server computer system) configured by an application may constitute a “module” that is configured and operates to perform certain operations as described herein. In other embodiments, the “module” may be implemented mechanically or electronically. For example, a module may comprise dedicated circuitry or logic that is configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and configured circuitry, or in temporarily configured circuitry (e.g. configured by software) may be driven by cost and time considerations. Accordingly, the term “module” should be understood to encompass a tangible entity, be that an entity that is physically constructed, configured (e.g., hardwired) or temporarily configured (e.g., programmed) to operate in a certain manner and/or to perform certain operations described herein. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical media and magnetic media.

The software may be transmitted over a network using a transmission medium. The term “transmission medium” shall be taken to include any medium that is capable of storing, encoding or carrying instructions for transmission to and execution by the machine, and includes a digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and derived therefrom, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense.

Thus, a listing watcher with alerts pushed to a mobile device is disclosed. While the present disclosure has been described in terms of several example embodiments, those of ordinary skill in the art will recognize that the present disclosure is not limited to the embodiments described, but may be practiced with modification and alteration within the spirit and scope of the appended claims. The description herein is thus to be regarded as illustrative instead of limiting.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system to communicate an alert to a mobile device, the system including:
a search module to receive, over a network, search information, the search information including item description information that describes an item;
a processing module to repeatedly search a first plurality of listings on a network-based marketplace, the processing module to repeatedly search the first plurality of listings to identify at least one listing that includes:
an item that matches the item description information and is offered for sale in an auction on the network-based marketplace,
a current highest bid for the item that is less than a price threshold, and
a time remaining in the auction that is less than a predetermined time threshold; and
a communication module to communicate, over the network, the alert to the mobile device, the communication module to communicate the alert responsive to the identification of the at least one listing.

2. The system of claim 2, wherein the processing module is to identify the price threshold based on a second plurality of listings.

3. The system of claim 2, wherein the processing module identities the second plurality of listings based on the item description information.

4. The system of claim 3, wherein the second plurality of listings respectively include a plurality of items associated with a plurality of winning bids, wherein the second plurality of items were respectively won in a plurality of auctions that were previously completed on the network-based marketplace.

5. The system of claim 4, wherein the processing module generates the price threshold based on the plurality of winning bids.

6. The system of claim 4, wherein the processing module generates the price threshold based on an average of the plurality of winning bids.

7. The system of claim 1, wherein the receiving module is to receive the search information that includes the price threshold.

8. The system of claim 1, wherein the receiving module is to receive the search information that includes the predetermined time threshold.

9. A method for communicating an alert to a mobile device, the method including:
receiving, over a network, search information including item description information that describes an item;
repeatedly searching a first plurality of listings on a network-based marketplace;
identifying at least one listing responsive to the searching, the at least one listing including:
an item that matches the item description information and is offered for sale in an auction on the network-based marketplace,
a current highest bid for the item that is less than a price threshold, and
a time remaining in the auction that is less than a predetermined time threshold; and
communicating, over the network, the alert to the mobile device, the communicating the alert responsive to the identifying of the at least one listing.

10. The method of claim 9, further including generating the price threshold based on a second plurality of listings.

11. The method of claim 9, further including identifying the second plurality of listings based on the item description information.

12. The method of claim 10, wherein the second plurality of listings respectively include a plurality of items associated with a plurality of winning bids, wherein the second plurality of items were respectively won in a plurality of auctions that were previously completed on the network-based marketplace.

13. The method of claim 11, wherein the generating the price threshold includes generating the price threshold based on the plurality of winning bids.

14. The method of claim 11, wherein the generating the price threshold includes generating the price threshold based on an average of the plurality of winning bids.

15. The method of claim 9, wherein the receiving the search information includes receiving the price threshold.

16. The method of claim 9, wherein the receiving the search information includes receiving the predetermined time threshold.

17. A machine-readable medium storing instructions that, when executed by a machine, cause the machine to:
receive, over a network, search information including item description information that describes an item;
repeatedly search a first plurality of listings on a network-based marketplace;
identify at least one listing responsive to the search, the at least one listing including:
an item that matches the item description information and is offered for sale in an auction on the network-based marketplace,
a current highest bid for the item that is less than a price threshold, and
a time remaining in the auction that is less than a predetermined time threshold; and
communicate, over the network, the alert to the mobile device, the communicating the alert responsive to the identifying the first listing.

18. A system to communicate an alert to a mobile device, the system including:
a search module to receive, over a network, search information, the search information includes item description information that describes an item to find;
a listing module to receive, over a network, item information for a listing of an item for publication on a network-based marketplace, the listing module to identify whether the item matches the item description information responsive to the receipt of the item information and before a publication of the listing on the network-based marketplace; and
a communication module to communicate the alert of the listing of the item, over the network, to a mobile device, the communication module to communicate the alert responsive to the identification of the match.

19. The system of claim 18, wherein the item description information is selected from a group consisting of a keyword, a category, a purchase price, a price range, a plurality of keywords not included in the listing information, a currency, and a shipping region.

20. The system of claim 18 wherein the receiving module is to receive the item description information from a buyer on the network-based marketplace and wherein the receiving module is to receive the item information for the listing of the item from a seller on the network-based marketplace.

21. The system of claim 18, wherein the communication module is to publish the listing of the item on the network-based marketplace after the communication module communicates the alert.

22. A method to communicate an alert to a mobile device, the method including:
receiving, over a network, search information, the search information including item description information that describes an item to find;
receiving, over a network, item information for a listing of an item for publication on a network-based marketplace;
identifying whether the item matches the item description information responsive to the receipt of the item information and before a publication of the listing on the network-based marketplace; and
communicating the alert of the listing of the item, over the network, to a mobile device, the communicating the alert being responsive to the identifying of the match.

23. The method of claim 22, wherein the item description information is selected from a group consisting of a keyword, a category, a purchase price, a price range, a plurality of keywords not included in the listing information, a currency, and a shipping region.

24. The method of claim 22 wherein the receiving the search information includes receiving the search information from a buyer on the network-based marketplace and wherein the receiving the item information includes receiving the item information from a seller on the network-based marketplace.

25. The method of claim 22, publishing the listing of the item on the network-based marketplace after the communicating the alert.

26. The method of claim 22 wherein the listing of the item includes an item that is available for a fixed-price purchase on the network-based marketplace.

27. The method of claim 22 wherein the listing of the item includes an item that is available for auction on the network-based marketplace.

28. The method of claim 22 wherein the alert is selected from a group of alerts consisting of an email, an short message service (SMS) message, an instant message, and a Blackberry Inbox Item.

29. A machine-readable medium storing instructions that, when executed by a machine, cause the machine to:
receive, over a network, search information, the search information including item description information that describes an item to find;
receive, over a network, item information for a listing of an item for publication on a network-based marketplace;
identify whether the item matches the item description information responsive to the receipt of the item information and before a publication of the listing on the network-based marketplace; and
communicating the alert of the listing of the item, over the network, to a mobile device, the communicating the alert being responsive to the identifying of the match.

30. A system to communicate an alert to a mobile device, the system including:
a means for receiving, over a network, search information, the search information including item description information that describes an item to find;
a listing module to receive, over a network, item information for a listing of an item for publication on a network-based marketplace, the listing module to identify whether the item matches the item description information responding to the receipt of the item information and before a publication of the listing on the network-based marketplace; and
a communication module to communicate the alert of the listing of the item, over the network, to a mobile device, the communication module to communicate the alert responsive to the identification of the match.
